(19) United States
(12) Patent Application Publication
(10) Pub. No.: US 2017/0337851 A1
(43) Pub. Date: Nov. 23, 2017

(54) REVEAL SUBSTRATES AND METHOD OF FORMING SAME

(71) Applicant: CLEARVUE, LLC, EASTON, PA (US)

(72) Inventors: JOHN V GUZZO, RIEGELSVILLE, PA (US); DANIEL F PETERS, HAMILTON, OH (US); RICKY L HELTON, CINCINNATI, OH (US)

(73) Assignee: CLEARVUE, LLC, EASTON, PA (US)

(21) Appl. No.: 15/598,006

(22) Filed: May 17, 2017

Related U.S. Application Data
(60) Provisional application No. 62/338,476, filed on May 18, 2016.

(51) Int. Cl. G09F 3/00; B44F 1/10; G09F 3/02

(52) U.S. Cl. CPC G09F 3/0291; B44F 1/10; G09F 2003/0202; G09F 2003/0257; G09F 2003/0226

(57) ABSTRACT

Provided is a reveal substrate including a release liner base stock layer; an adhesive layer; a label base stock layer; a thermal insulation layer disposed over the label base stock layer; an ink layer disposed over the thermal insulation layer, the ink layer comprising at least one color; a reveal coat layer disposed over the printed ink layer; and a top coat layer disposed over the reveal coat layer. The reveal coat layer includes an acrylic-based composition including light-scattering particles which cause the reveal coat layer to be opaque in a first state and transparent in a second state, the application of at least one of heat and pressure from a print head causing the reveal coat layer to transition from the first state to the second state, thereby enabling the at least one color of the ink layer to be visible through the reveal coat layer.

### PRIORITY

This application claims to U.S. Provisional Patent Application No. 62/338,476 filed May 18, 2016.

### FIELD OF INTEREST

The present disclosure relates to the field of printing and, more particularly, to reveal printing substrates and methods of forming reveal printing substrates.

### RELATED PATENT

This application is related to U.S. Pat. No. 8,054,323, the entire contents of which are hereby incorporated by reference.

### SUMMARY

In accordance with an aspect of the inventive concept, provided is a reveal substrate comprising a release liner base stock layer; an adhesive layer; a label base stock layer; a thermal insulation layer disposed over the label base stock layer; an ink layer disposed over the thermal insulation layer, the ink layer comprising at least one color; a reveal coat layer disposed over the printed ink layer; and a top coat layer disposed over the reveal coat layer. The reveal coat layer may include an acrylic-based composition including light-scattering particles which cause the reveal coat layer to be opaque in a first state and transparent in a second state, the application of at least one of heat and pressure from a print head causing the reveal coat layer to transition from the first state to the second state, thereby enabling the at least one color of the ink layer to be visible through the reveal coat layer.

According to various embodiments, the application of at least one of heat and pressure from the print head may cause the light-scattering particles to change form, thereby reducing light scattering properties thereof.

According to various embodiments, the label base stock layer may include paper, the reveal substrate further comprising a barrier layer formed on at least one side of the label base stock layer.

In accordance with other aspects of the inventive concept, provided is a reveal substrate including a release liner base stock layer; an adhesive layer; a paper-based label base stock layer; a barrier layer formed on at least one side of the label base stock layer; a thermal insulation layer disposed over the label base stock layer; an ink layer disposed over the thermal insulation layer, the ink layer comprising at least one color; a reveal coat layer disposed over the printed ink layer; and a top coat layer disposed over the reveal coat layer. The reveal coat layer may include an acrylic-based composition including light-scattering particles which cause the reveal coat layer to be opaque in a first state and transparent in a second state, the application of at least one of heat and pressure from a print head causing the reveal coat layer to transition from the first state to the second state, thereby enabling the at least one color of the ink layer to be visible through the reveal coat layer.

In accordance with other aspects of the inventive concept, provided is reveal substrate including a label base stock layer; an activatable adhesive layer disposed over a first side of the label base stock layer; a thermal insulation layer disposed over a second side of the label base stock layer, opposite the first side; an ink layer disposed over the thermal insulation layer, the ink layer comprising at least one color; a reveal coat layer disposed over the printed ink layer; and a top coat layer disposed over the reveal coat layer; the reveal coat layer may include an acrylic-based composition including light-scattering particles which cause the reveal coat layer to be opaque in a first state and transparent in a second state, the application of at least one of heat and pressure from a print head causing the reveal coat layer to transition from the first state to the second state, thereby enabling the at least one color of the ink layer to be visible through the reveal coat layer.

In accordance with other aspects of the inventive concept, provided is reveal substrate including a label base stock layer; a thermal insulation layer disposed over the label base stock layer; an ink layer disposed over the thermal insulation layer, the ink layer comprising at least one color; a reveal coat layer disposed over the printed ink layer; and a top coat layer disposed over the reveal coat layer. The reveal coat layer may include an acrylic-based composition including light-scattering particles which cause the reveal coat layer to be opaque in first state and transparent in a second state, the application of at least one of heat and pressure from a print head causing the reveal coat layer to transition from the first state to the second state, thereby enabling the at least one color of the ink layer to be visible through the reveal coat layer.

In accordance with other aspects of the inventive concept, provided is reveal substrate including a release liner base stock layer; a first adhesive layer disposed over a first side of the release liner base stock; a first label base stock layer disposed over the first adhesive layer; a first thermal insulation layer disposed over the first label base stock layer; a first ink layer disposed over the first thermal insulation layer, the first ink layer comprising at least one color; a first reveal coat layer disposed over the first printed ink layer; a first top coat layer disposed over the first reveal coat layer; a second adhesive layer disposed over a second side of the release liner base stock; a second label base stock layer disposed over the second adhesive layer; a second thermal insulation layer disposed over the second label base stock layer; a second ink layer disposed over the second thermal insulation layer, the second ink layer comprising at least one color; a second reveal coat layer disposed over the second printed ink layer; a second top coat layer disposed over the second reveal coat layer. The first and second reveal coat layers each may include an acrylic-based composition including light-scattering particles which cause the reveal coat layer to be opaque in a first state and transparent in a second state, the application of at least one of heat and pressure from a print head causing the reveal coat layer to transition from the first state to the second state, thereby enabling the at least one color of the first and second ink layers, respectively, to be visible through the reveal coat layer.

In accordance with other aspects of the inventive concept, provided is reveal substrate including a release liner base stock layer; a first adhesive layer disposed over a first side of the release liner base stock; a first label base stock layer disposed over the first adhesive layer; a first thermal insulation layer disposed over the first label base stock layer; a first ink layer disposed over the first thermal insulation layer, the first ink layer comprising at least one color; a first reveal coat layer disposed over the first printed ink layer; a first top coat layer disposed over the first reveal coat layer; a second label base stock layer disposed over the release liner base stock layer; a second thermal insulation layer disposed over the second label base stock layer; a second ink layer disposed over the second thermal insulation layer, the second ink layer comprising at least one color; a second reveal coat layer disposed over the second printed ink layer; a second top coat layer disposed over the second reveal coat layer. The first and second reveal coat layers each may include an acrylic-based composition including light-scattering particles which cause the reveal coat layer to be opaque in a first state and transparent in a second state, the application of at least one of heat and pressure from a print head causing the reveal coat layer to transition from the first state to the second state, thereby enabling the at least one color of the first and second ink layers, respectively, to be visible through the reveal coat layer.

In accordance with other aspects of the inventive concept, provided is reveal substrate including a release liner base stock layer; an adhesive layer; a transparent film-based label base stock layer; an ink layer disposed over a first side of the label base stock layer, the ink layer comprising at least one color; a thermal insulation layer disposed over a second side of the label base stock layer, opposite the first side; a reveal coat layer disposed over the thermal insulation layer; and a top coat layer disposed over the reveal coat layer. The reveal coat layer may include an acrylic-based composition including light-scattering particles which cause the reveal coat layer to be opaque in a first state and transparent in a second state, the application of at least one of heat and pressure from a print head causing the reveal coat layer to transition from the first state to the second state, thereby enabling the at least one color of the ink layer to be visible through the reveal coat layer and the transparent film-based label base stock layer.

In accordance with other aspects of the inventive concept, provided is a reveal substrate including a release liner base stock layer; an adhesive layer including a coloring pigment; a transparent film-based label base stock layer; a thermal insulation layer disposed over the label base stock layer; a reveal coat layer disposed over the thermal insulation layer; and a top coat layer disposed over the reveal coat layer. The reveal coat layer may include an acrylic-based composition including light-scattering particles which cause the reveal coat layer to be opaque in a first state and transparent in a second state, the application of at least one of heat and pressure from a print head causing the reveal coat layer to transition from the first state to the second state, thereby enabling the coloring pigment of the adhesive layer to be visible through the reveal coat layer and the transparent film-based label base stock layer.

In accordance with other aspects of the inventive concept, provided is a reveal substrate including a release liner base stock layer; a transparent adhesive layer; a transparent film-based label base stock layer; a thermal insulation layer disposed over the label base stock layer; a reveal coat layer disposed over the thermal insulation layer; and a top coat layer disposed over the reveal coat layer. The reveal coat layer may include an acrylic-based composition including light-scattering particles which cause the reveal coat layer to be opaque in a first state and transparent in a second state, the application of at least one of heat and pressure from a print head causing the reveal coat layer to transition from the first state to the second state, thereby enabling a color of an object to which the reveal substrate is affixed to be visible through the reveal coat layer and the transparent film-based label base stock layer.

In accordance with other aspects of the inventive concept, provided is a reveal substrate including a transparent activatable adhesive layer; a transparent film-based label base stock layer; a thermal insulation layer disposed over the label base stock layer; a reveal coat layer disposed over the thermal insulation layer; and a top coat layer disposed over the reveal coat layer. The reveal coat layer may include an acrylic-based composition including light-scattering particles which cause the reveal coat layer to be opaque in a first state and transparent in a second state, the application of at least one of heat and pressure from a print head causing the reveal coat layer to transition from the first state to the second state, thereby enabling a color of an object to which the reveal substrate is affixed to be visible through the reveal coat layer and the transparent film-based label base stock layer.

In accordance with other aspects of the inventive concept, provided is a reveal substrate including an activatable adhesive layer including a coloring pigment; a transparent film-based label base stock layer; a thermal insulation layer disposed over the label base stock layer; a reveal coat layer disposed over the thermal insulation layer; and a top coat layer disposed over the reveal coat layer. The reveal coat layer comprises an acrylic-based composition including light-scattering particles which cause the reveal coat layer to be opaque in a first state and transparent in a second state, the application of at least one of heat and pressure from a print head causing the reveal coat layer to transition from the first state to the second state, thereby enabling the coloring pigment of the activatable adhesive layer to be visible through the reveal coat layer and the transparent film-based label base stock layer.

in accordance with other aspects of the inventive concept, provided is method of forming a reveal substrate including depositing a silicone layer over a release liner base stock; depositing an adhesive layer over the silicone layer; depositing a barrier layer over the adhesive layer; depositing a label base stock layer over the barrier layer; depositing a thermal insulation layer over the label base stock layer; depositing an ink layer over the thermal insulation layer, the ink layer including at least one color; depositing reveal coat layer over the ink layer; and depositing a top coat layer over the reveal coat layer. The reveal coat layer may include an acrylic-based composition including light-scattering particles which cause the reveal coat layer to be opaque in a first state and transparent in a second state, the application of at least one of heat and pressure from a print head causing the reveal coat layer to transition from the first state to the second state, thereby enabling the at least one color of the ink layer to be visible through the reveal coat layer.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIGS. 1-4 are cross-sectional views of various embodiments of the disclosure;

FIG. 5 is a top view of a substrate in accordance with embodiments of the disclosure;

FIGS. 6-8 are cross-sectional views of various embodiments of the disclosure;

FIG. 9 is a top view of a substrate in accordance with embodiments of the disclosure;

FIGS. 10-13 are cross-sectional views of various embodiments of the disclosure; and

FIG. 14 is a flow diagram depicting a process followed to form an embodiment of the reveal substrate in accordance with embodiments of the disclosure.

### DETAILED DESCRIPTION

Various aspects of the inventive concepts will be described more fully hereinafter with reference to the accompanying drawings, in which some exemplary embodiments are shown. The present inventive concept may, however, be embodied in many different forms and should not be construed as limited to the exemplary embodiments set forth herein.

It will be understood that, although the terms first, second, etc. are used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

Exemplary embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but are to include deviations in shapes that result, for example, from manufacturing.

To the extent that functional features, operations, and/or steps are described herein, or otherwise understood to be included within various embodiments of the inventive concept, such functional features, operations, and/or steps can be embodied in functional blocks, units, modules, operations and/or methods. And to the extent that such functional blocks, units, modules, operations and/or methods include computer program code, such computer program code can be stored in a computer readable medium, e.g., such as non-transitory memory and media, that is executable by at least one computer processor.

The present disclosure is directed to a thermal or pressure reveal substrate in which, when a thermal and/or pressure printing head applies heat and/or pressure to the substrate, an opaque reveal coating layer of the substrate is caused to turn translucent or transparent, thereby revealing the color of an ink layer or other coloring beneath the reveal coating layer. Prior to the application of heat and/or pressure, the opaque reveal coating layer may completely block the underlying coloring from view.

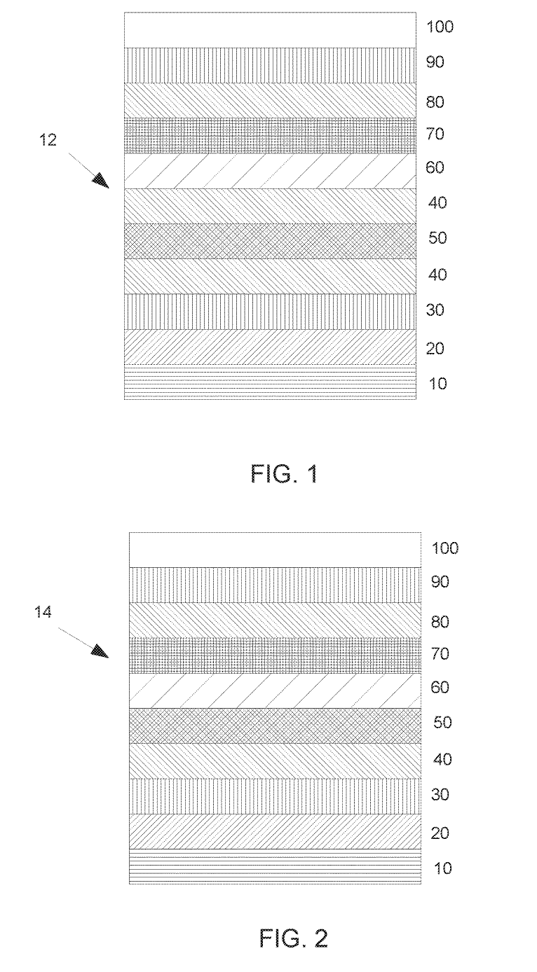

FIG. 1 is a diagram illustrating a cross-sectional view of an embodiment of a reveal substrate 12 formed as an adhesive label. As shown in FIG. 1, the substrate 12 may include multiple layers 10-100 that make up the thickness of the substrate 12 from a lower layer 10 to an upper layer 100. It will be understood that the relative thicknesses shown in the figures is not to scale and, as is described below, some layers may be optional, depending on specific applications.

in the embodiment 12 shown in FIG. 1, layer 10 may comprise a release liner base stock. This layer is the backing that protects adhesive layer 30 until the label is to be affixed to an object. This may be formed of paper, including, but not limited to, Densified Kraft, Polycoated Kraft, Extensible Polycoated Kraft, supercalendered paper, clay-coated paper, Polycoated paper, machine finished (“MF”) graded paper and machine coated (“MC”) graded paper. Alternatively, layer 10 may comprise a film, including, but not limited to, polypropylene, high-density polypropylene (HDPE), polyester (PET) and polyethylene (PE). The weight per unit of area of layer 10 may be in the range of 20-180 g/m².

Layer 20 may comprise a silicone coating, including, but not limited to, water-based silicone, solvent-based silicone and silicone formed from 100% solids. The silicone may be thermal cured, UV cured, electron beam cured or cured by any other means commonly known in the art. Further, the silicone may be catalyzed with platinum, tin, rhodium or other elements. The weight per unit of area of layer 20 may be in the range of 1-10 g/m2. The silicone layer 20 enables the release liner base stock to be easily removed from the adhesive layer 30 of the label.

Layer 30 may comprise a pressure sensitive adhesive layer including, but not limited to, acrylic, rubber and ethylene vinyl acetate (EVA). The adhesive may be a water-based adhesive, a solvent-based adhesive, an adhesive formed from 100% solids or another appropriate form of adhesive known in the art. Further, depending on the specific application, the adhesive may be permanent, removable, low-temperature, freezer grade, etc. The weight per unit of area of layer 30 may be in the range of 5-30 g/m². Adhesive layer 30 enables the label to be affixed to an object.

Layers 40 may comprise a barrier coat, which, in the embodiment of FIG. 1, is formed on both surfaces of the label base stock layer 50. Barrier layers 40 may serve the purpose of preventing the adhesive from seeping into the label base stock layer 50 and through the label base stock layer 50 into the upper layers of the substrate 12. Barrier coat layer 40 may include, but is not limited to, acrylic, polyvinyl acetate (PVA), polyvinyl alcohol (PVOH) and EVA, and may be water-based, solvent-based, formed from 100% solids or other appropriate forms. The weight per unit of area of layer 40 may be in the range of 1-10 g/m².

Layer 50 may comprise the label base stock. This may be formed of paper, including, but not limited to, uncoated paper, C1S paper, C2S paper, synthetic paper and clay-coated paper. Alternatively, layer 50 may comprise a film, including, but not limited to, polypropylene, high-density polypropylene (HDPE), polyester (PET) and polyethylene (PE). The weight per unit of area of layer 50 may be in the range of 20-220 g/m².

Layer 60 may comprise a thermal insulation layer. Thermal insulation layer 60 may serve the purpose of concentrating heat applied from a heat print head in the reveal coat layer and preventing the heat from traversing deeply into the substrate. “Trapping” the heat in the reveal coat layer enables the reveal coat layer to more fully and clearly transform into a transparent state, as described below. The more concentrated the heat is in the applied locations, the more crisp and clear the printed areas will be. This layer may be transparent, translucent or opaque, and may comprise large-diameter hollow spheres or other shaped objects formed from styrene or other suitable material, combined with various fillers and binders including, but not limited to, acrylic resin and PVOH. In one embodiment, the diameter of the large-diameter spheres may be in the range of approximately 1 to 2 μm. The weight per unit of area of layer 60 may be in the range of 1-10 g/m². In one embodiment, the weight per unit of area of layer 60 may be in the range of 2-6 g/m².

Layer 70 may comprise a printed ink layer. Any type of suitable ink may be used, and the layer may comprise one or more colors. For example, layer 70 may cover the entire width and length of the substrate 12 with a single color, or multiple colors may be printed to cover predetermined regions of the substrate. This enables a label to be printed with multiple colors, depending on the areas of the substrate subjected to the thermal and/or pressure printing process. The weight per unit of area of layer 70 may be in the range of 1-5 g/m².

Layer 80 may comprise a reveal coat layer. As described above, reveal coat layer 80 is initially opaque, thereby blocking the printed ink layer 70 from view. In one embodiment, the reveal coat is white in color. Upon the application of heat and/or pressure by a thermal and/or pressure print head to specific areas of the reveal coat layer 80, the reveal coat layer, in the specific areas, turns transparent, thereby revealing the printed ink layer. The result is portions of the printed ink layer under the transparent reveal coat portion forming the printed text, graphics, etc.

Reveal coat layer 80 may comprise small-diameter hollow spheres formed from styrene or other suitable material, combined with various fillers and binders, including, but not limited to, acrylic resin, styrene butadiene, PVOH, starch-based binders and polyesters. Reveal coat layer 80 may also comprise a sensitizer, including, but limited to a plasticizer and a thermal solvent, for lowering the melting point of the reveal coat, thereby rendering the reveal coat more reactive to the heat applied by a thermal print head. Optionally, the reveal coat may include wax, pigments for coloring the reveal coat and optical brighteners for brightening, in particular, a white reveal coat. Cross-linking material may also be included, which hardens the reveal coat, making it more resistant to scratching or other damage. In one embodiment, the diameter of the small-diameter spheres may be approximately 0.5 μm.

The small-diameter spheres of the reveal coat layer 80 cause the reveal coat to be opaque because they scatter light impinging the material. The shape of the spheres and the voids there between cause the light-scattering effect. When heat is applied to the reveal coat, the spheres are melted and, as a result, flatten and lose their spherical shapes, causing the reveal coat to become transparent, which enables light to pass through the reveal coat to the ink layer, making the ink layer visible. Similarly, when pressure is applied to the reveal coat, the spheres are substantially flattened and, as a result, lose their spherical shapes, causing the reveal coat to become transparent, which enables light to pass through the reveal coat to the ink layer, making the ink layer visible.

In various embodiments, the concentration of materials included in the reveal coat may fall into these approximate ranges:

Small-diameter spheres: 20-80%

Binder: 20-80%

Sensitizer: 10-50%

Wax: 5-50%

Fillers: 0-20%

Pigments: 0-20%

Optical brighteners: 0-20%

Cross-linking material: 0-10%

In a specific embodiment, the concentration of materials included in the reveal coat may fall into these approximate ranges:

Small-diameter spheres: 30-40%

Binder: 30-40%

Sensitizer: 15-25%

Wax: 5-15%

Fillers: 0-5%

Pigments: 0-10%

Optical brighteners: 1-5%

Cross-linking material: 0-5%

While the embodiment described above includes small-diameter spheres, it will be understood that any shape particle that scatters light when intact, but allows it to pass through upon the application of heat and/or pressure may be used, such as flakes, rods, etc.

The weight per unit of area of layer 80 may be in the range of 2-20 g/m². In one embodiment, the weight per unit of area of layer 80 may be in the range of 5-10 g/m².

Layer 90 may comprise a top coat layer. Top coat layer 90 may serve the purpose of protecting the reveal coat layer 80 and also facilitating the passage of the print head across the substrate 12. Top coat layer 90 may include a core/shell technology heat-resistant acrylic for preventing lower-level heat sources (those other than a thermal print head) from inadvertently affecting the opacity of the reveal coat. Binders, such as PVOH, abrasive fillers, such as clay, wax, cross-linking material, optical brighteners and hollow spheres of styrene or other material may also be included in the top coat layer 90. The hollow spheres may be included to increase the opacity of the substrate 12. In one embodiment, the wax provides a lubricated surface for the print head to pass over, particularly in the presence of heat from the print head, and the abrasive filler provides a texture to clean the thermal print head as it passes across it. Since the composition of the top coat is not totally homogenous, there are higher concentrations of, for example, wax, in certain locations and the abrasive filler in others. This enables each material to serve its purpose during the printing process.

In various embodiments, the concentration of materials included in the top coat may fall into these approximate ranges:

Core/shell acrylic: 20-80%

Binder: 0-50%

Abrasive filler: 0-50%

Wax: 0-30%

Cross-linking material: 0-10%

Optical brightener: 0-20%

Hollow spheres 0-20%

in a specific embodiment, the concentration of materials included in the top coat may fall into these approximate ranges:

Core/shell acrylic: 40-50%

Binder: 0-10%

Abrasive filler: 15-25%

Wax: 10-20%

Cross-linking material: 0-3%

Optical brightener: 0-5%

Hollow spheres 0-10%

While the embodiment described above includes small-diameter spheres, it will be understood that any shape particle that scatters light when intact, but allows it to pass through upon the application of heat and/or pressure may be used, such as flakes, rods, etc.

The weight per unit of area of layer 90 may be in the range of 2-20 g/m². In one embodiment, the weight per unit of area of layer 90 may be in the range of 2-5 g/m².

Layer 100 is an optional printed layer, in which information that will be constant on multiple labels may be printed. Examples of such include a company logo or other information of the seller of the product to which the label is affixed. The weight per unit of area of layer 100 may be in the range of 1-5 g/m².

FIG. 2 is a diagram illustrating a cross-sectional view of another embodiment of a reveal substrate 14 formed as an adhesive label. In this embodiment, a single barrier coat layer 40 is disposed between the adhesive layer 30 and the label base stock 50. No barrier layer is formed on the opposite surface of the label base stock 50.

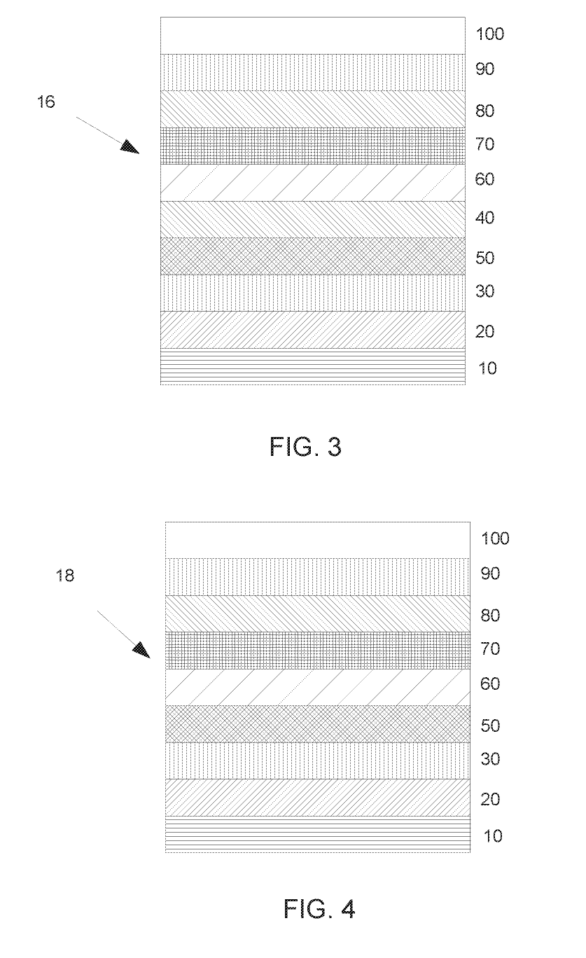

FIG. 3 is a diagram illustrating a cross-sectional view of another embodiment of a reveal substrate 16 formed as an adhesive label. In this embodiment, a single barrier coat layer 40 is disposed between the label base stock 50 and the thermal insulation layer 60. No barrier layer is formed on the opposite surface of the label base stock 50.

FIG. 4 is a diagram illustrating a cross-sectional view of another embodiment of a reveal substrate 18 formed as an adhesive label. In this embodiment, no barrier layers are included in the substrate. This may be preferable in the case where the label base stock 50 is formed from a film, as the film acts as a barrier between the adhesive and the upper layers of the substrate.

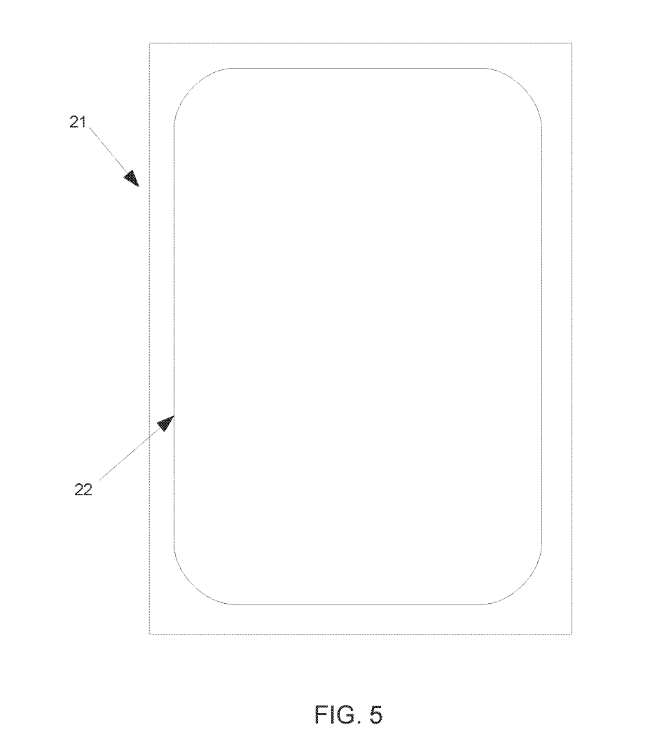

FIG. 5 is a diagram illustrating a top view of a label substrate 21 in accordance with various embodiments of this disclosure. As shown, the substrate 21 has a rectangular shape and includes a die cut label portion 22, which may include layers 30-100. After a printing process is performed on the substrate, the die cut label portion 22 may be peeled off of the release liner base stock layer 10 (and silicone layer 20), thereby exposing the adhesive layer 30, which enables the label to be affixed to an object. It will be understood that substrate 21 and die cut label portion 2.2 may be any shape or size and one or more die cut portions may be formed on a single substrate.

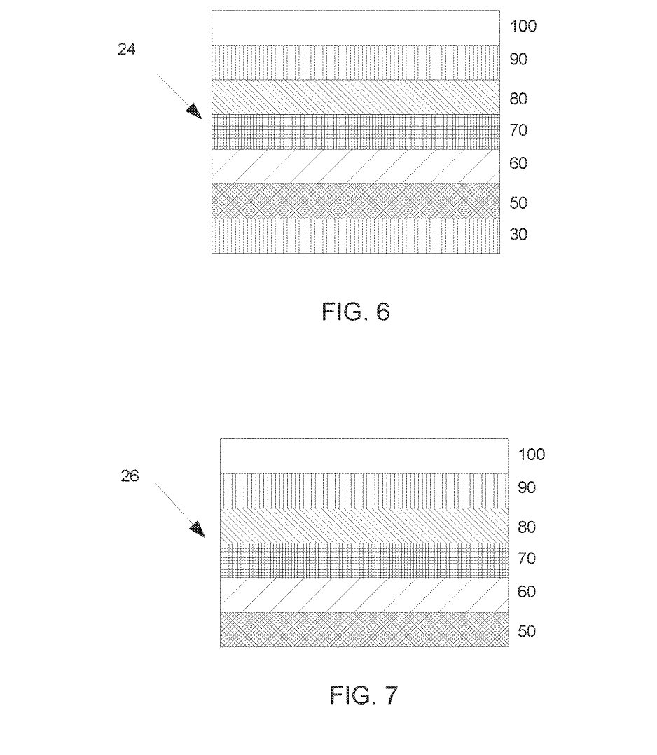

FIG. 6 is a diagram illustrating a cross-sectional view of another embodiment of a reveal substrate 24 formed as an adhesive label. In this embodiment, adhesive layer 30 is formed from an activatable adhesive, which may be activated by heat, moisture, UV energy, or other appropriate means. Since the activatable adhesive layer 30 is not sticky until it is activated, there is no need for the release liner base stock layer 10 and the silicone layer 20. Further, in this embodiment, if the label base stock layer 50 comprises a film, barrier layer 40 may not be included. However, in the case of a paper label base stock layer 50, as described above, a barrier layer 40 may be included on one or both sides of the label base stock layer.

FIG. 7 is a diagram illustrating a cross-sectional view of another embodiment of a reveal substrate 26 formed as a non-adhesive sheet, such as receipt substrate, packing slip substrate or any other printed substrate that does not require adhesive for affixing the substrate to a surface. In this embodiment, layers 10-30 are omitted. In the case that the label base stock layer 50 comprises a film, barrier layer 40 may not be included. However, in the case of a paper label base stock layer, as described above, a barrier layer 40 may be included on one or both sides of the label base stock layer.

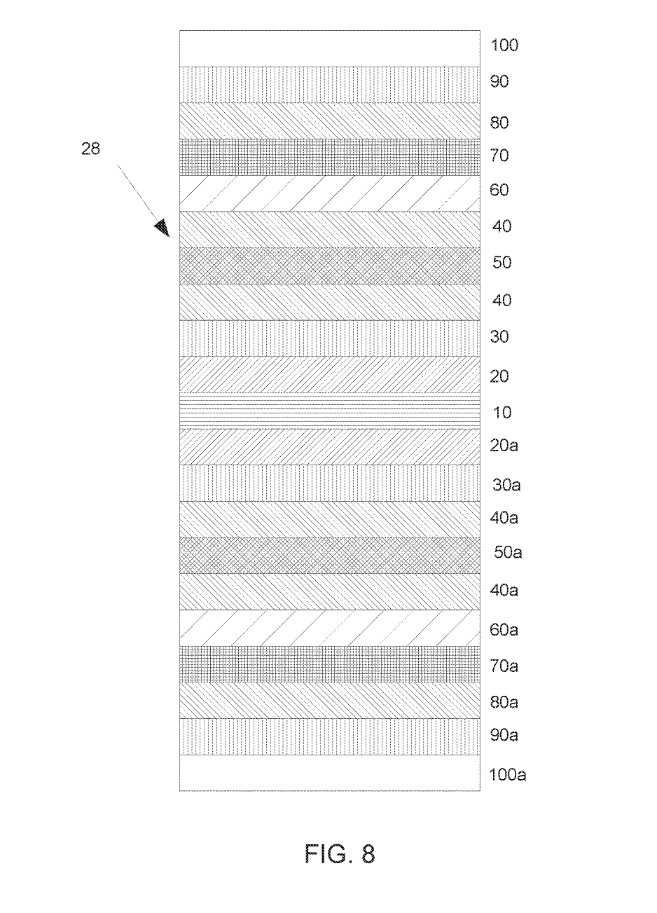

FIG. 8 is a diagram illustrating a cross-sectional view of another embodiment of a reveal substrate 28 formed as a double-sided adhesive label. In this embodiment, layers 10-100 are substantially similar to layers 10-100 described above with reference to FIG. 1. Substrate 28 further includes layers 20a-100a. to effect a double-sided adhesive layer. As shown, layers 20a-100a are formed on a back side of release liner base stock layer 10 in a manner that substantially mirrors the formation of layers 20-100 on the opposite side. Layers 20a-100a may be substantially similar in composition as the corresponding layers 20-100.

Double-sided substrate 28 may be formed similarly to substrate 21 of FIG. 5, however, having a die cut portion cut through layers 20-100 on one side and through layers 20a-100a on the opposite side. In this embodiment, the substrate may be passed through a double-sided printing machine having multiple print heads, each directing heat and/or pressure to a different side of the substrate to print two labels at the same time. Each label may then be peeled from the release liner base stock layer 10 for affixment to a surface.

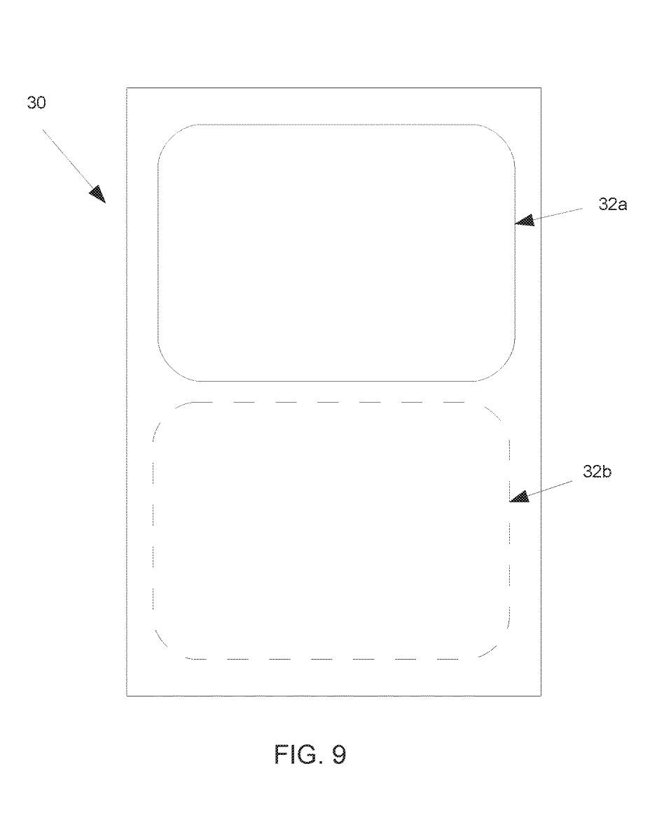

FIG. 9 is a diagram illustrating a top view of a label substrate 30 in accordance with various embodiments of this disclosure. As shown, the substrate 30 includes a first die cut portion 32a on one side, shown in a solid line and a second die cut portion 32b on an opposite side of the substrate, shown in a dashed line. Each portion 32a, 32b may be removed from the release liner base stock layer 10 for affixment to a surface.

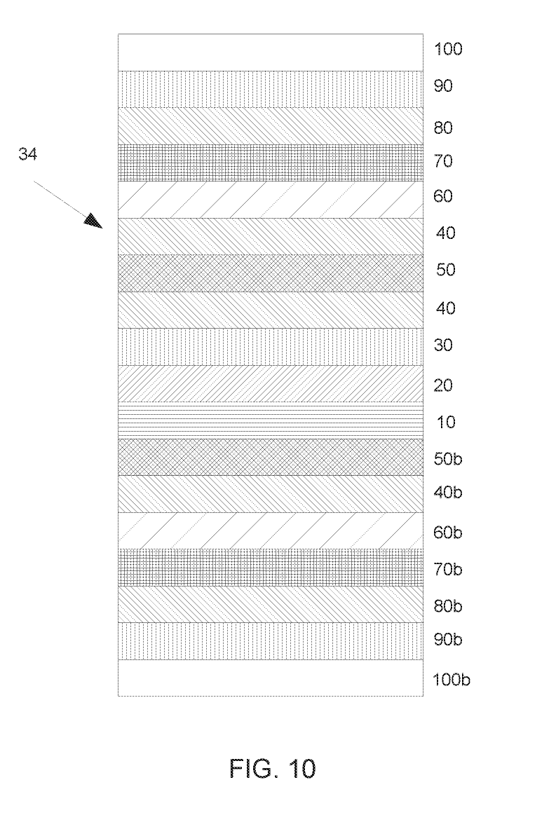

FIG. 10 is a diagram illustrating a cross-sectional view of another embodiment of a reveal substrate 34 formed as a double-sided substrate. In this embodiment, layers 10-100 are substantially similar to layers 10-100 described above with reference to FIG. 1. Substrate 34 further includes layers 50a-100a to effect a double-sided substrate, with layers 20-100 being used to form an adhesive label and layers 10 and 50a-100a being used as printed, non-adhesive stock. As shown, layers 50a-100a are formed on a back side of release liner base stock layer 10 in a manner that substantially mirrors the formation of layers 50-100 on the opposite side. In this embodiment, layers 50a-100a may be substantially similar in composition as the corresponding layers 50-100.

Similar to the substrate 28, substrate 34 may be passed through a double-sided printing machine having multiple print heads, each directing heat and/or pressure to a different side of the substrate to print both sides at the same time. The label comprising layers 20-100 may then be peeled from the release liner base stock layer 10 for affixment to a surface and the portion comprising layers 10 and 50a-100a may be used as a packing slip or other non-adhesive printed stock.

FIG, 11 is a diagram illustrating a cross-sectional view of another embodiment of a reveal substrate 36. In this embodiment, label base stock 50 comprises a clear film. Printed ink layer 70 is formed on the underside of label base stock 50, between the label base stock 50 and a barrier layer 40. When the thermal and/or pressure printing process takes place, and the reveal layer 80 is rendered transparent in certain areas, the color of printed ink layer 70 will be visible through the transparent film of the label base stock 50. In this embodiment, printed ink layer 70 is protected by the film label base stock 50 from inadvertent exposure or contamination.

Substrate 36 may also be formed using an activatable adhesive layer 30, as described above. In such a case, release liner base stock layer 10 and silicone layer 20 are not included.

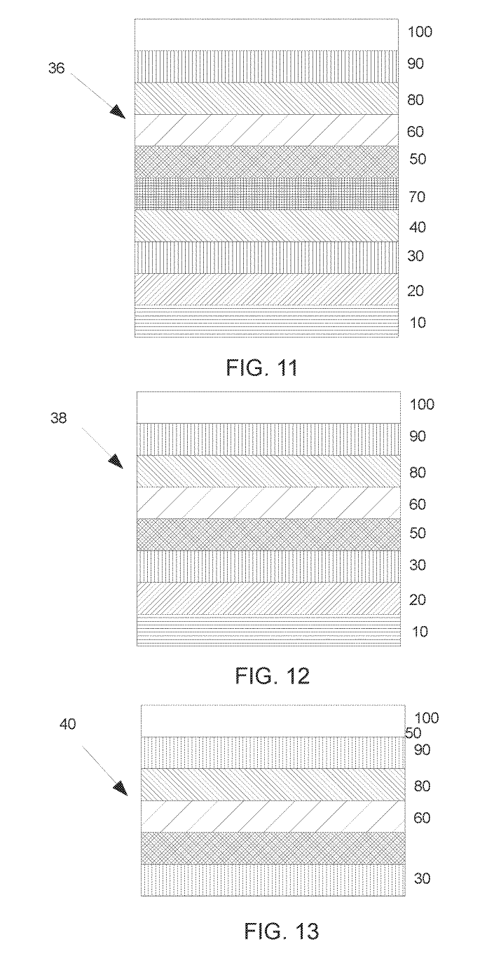

FIG. 12 is a diagram illustrating a cross-sectional view of another embodiment of a reveal substrate 38. In this embodiment, label base stock 50 comprises a clear film and no printed ink layer 70 is included. In place of a printed ink layer, adhesive layer 30 may comprise a pigmented adhesive, having a predetermined coloring. In this case, when the thermal and/or pressure printing process takes place, and the reveal layer 80 is rendered transparent in certain areas, the color of pigmented adhesive layer 30 will be visible through the transparent film of the label base stock 50.

Alternatively, in place of a printed ink layer, adhesive layer 30 may comprise a clear adhesive. As described above, when the thermal and/or pressure printing process takes place, the reveal layer 80 is rendered transparent in certain areas. Accordingly, the printed portion, being transparent, will take on the color of whatever surface the label is affixed to, since that color will be visible through the transparent film of the label base stock 50.

FIG. 13 is a diagram illustrating a cross-sectional view of another embodiment of a reveal substrate 40. In this embodiment, label base stock 50 comprises a clear film and no printed ink layer is utilized. In place of a printed ink layer, adhesive layer 30 may comprise an activatable pigmented adhesive, having a predetermined coloring. In this case, when the thermal and/or pressure printing process takes place, and the reveal layer 80 is rendered transparent in certain areas, the color of activatable pigmented adhesive layer 30 will be visible through the transparent film of the label base stock 50. In this embodiment, release liner base stock layer 10 and silicone layer 20 are not utilized.

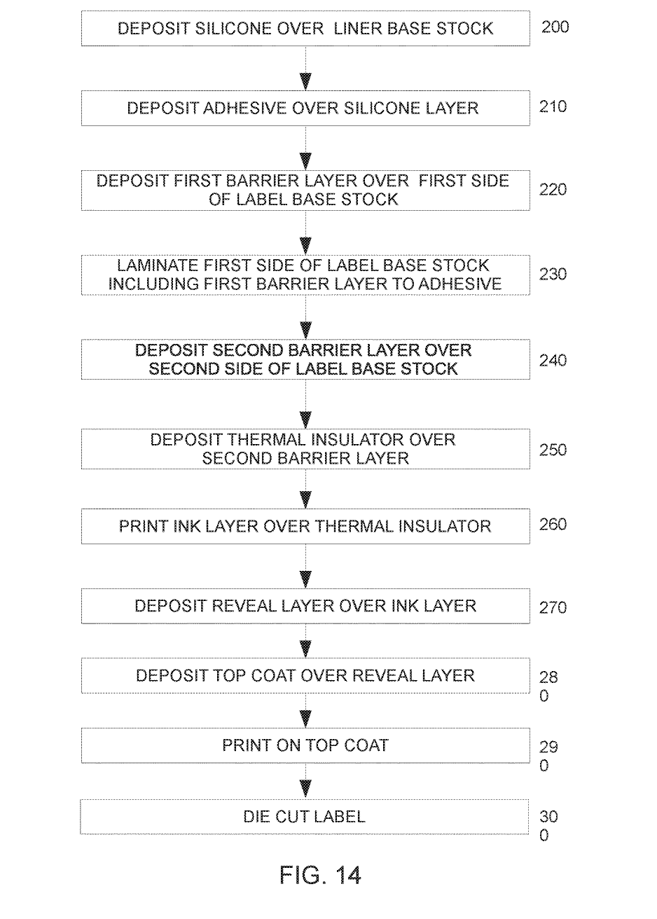

FIG. 14 is a flow diagram illustrating steps for forming a substrate in accordance with the embodiment described with reference to FIG. 1. In Step 200, the silicone layer 20 is deposited over the liner base stock 10. Adhesive 30 is deposited over silicone layer 20, Step 210, and a first barrier layer 40 is deposited over a first side of label base stock 50, Step 220. The label base stock 50 is laminated onto the adhesive layer 30, with the first barrier layer between the label base stock and the adhesive layer, Step 230, and a second barrier layer 40 is deposited over the label base stock 50, Step 240. Thermal insulation layer 60 is deposited over barrier layer 40, Step 250, and ink layer 70 is printed over thermal insulation layer 60, Step 260. Reveal coat layer 80 is deposited over ink layer 70, Step 270, and top coat layer 90 is deposited over reveal coat layer 80, Step 280. Layer 100 may then be printed onto the top coat layer 90, Step 290. The label may then be die cut on the substrate, Step 300. Alternatively, layer 100 may be printed on the top coat layer 90 after the die cutting step 300.

While FIG. 14 depicts the process carried out to form the substrate 12 of FIG. 1, it will be understood that similar processes may be utilized to form each of the other embodiments described, with certain steps being omitted, repeated and/or performed in a different order.

While the foregoing has described what are considered to be the best mode and/or other preferred embodiments, it is understood that various modifications can be made therein and that the invention or inventions may be implemented in various forms and embodiments, and that they may be applied in numerous applications, only some of which have been described herein. For example, although barrier layers may not be included in substrates using a film label base stock, barrier layers may be used in such substrates for any of a number of purposes. Instead of the silicone layer 20, the release liner base stock may be formed of materials that facilitate easy and complete removal of the release liner base stock from the adhesive without damaging or upsetting the adhesive layer. Further, variations on the order of various layers may be implemented without departing from the inventive concepts described herein. It is intended by the following claims to claim that which is literally described and all equivalents thereto, including all modifications and variations that fall within the scope of each claim.

What is claimed is:

1. A reveal substrate comprising:
a release liner base stock layer;
an adhesive layer;
a label base stock layer;
a thermal insulation layer disposed over the label base stock layer;
an ink layer disposed over the thermal insulation layer, the ink layer comprising at least one color;
a reveal coat layer disposed over the printed ink layer; and
a top coat layer disposed over the reveal coat layer;
wherein the reveal coat layer comprises an acrylic-based composition including light-scattering particles which cause the reveal coat layer to be opaque in a first state and transparent in a second state, the application of at least one of heat and pressure from a print head causing the reveal coat layer to transition from the first state to the second state, thereby enabling the at least one color of the ink layer to be visible through the reveal coat layer.

2. The reveal substrate of claim 1, wherein the application of at least one of heat and pressure from the print head causes the light-scattering particles to change form, thereby reducing light scattering properties thereof.

3. The reveal substrate of claim 1, wherein the label base stock layer comprises paper, the reveal substrate further comprising a barrier layer formed on at least one side of the label base stock layer.

4. A reveal substrate comprising:
a label base stock layer;
a thermal insulation layer disposed over the label base stock layer;
an ink layer disposed over the thermal insulation layer, the ink layer comprising at least one color;
a reveal coat layer disposed over the printed ink layer; and
a top coat layer disposed over the reveal coat layer;
wherein the reveal coat layer comprises an acrylic-based composition including light-scattering particles which cause the reveal coat layer to be opaque in a first state and transparent in a second state, the application of at least one of heat and pressure from a print head causing the reveal coat layer to transition from the first state to the second state, thereby enabling the at least one color of the ink layer to be visible through the reveal coat layer.

5. A reveal substrate comprising:
a transparent activatable adhesive layer;
a transparent film-based label base stock layer;
a thermal insulation layer disposed over the label base stock layer;
a reveal coat layer disposed over the thermal insulation layer; and
a top coat layer disposed over the reveal coat layer;
wherein the reveal coat layer comprises an acrylic-based composition including light-scattering particles which cause the reveal coat layer to be opaque in a first state and transparent in a second state, the application of at least one of heat and pressure from a print head causing the reveal coat layer to transition from the first state to the second state, thereby enabling a color of an object to which the reveal substrate is affixed to be visible through the reveal coat layer and the transparent film-based label base stock layer.
